(19) United States
(12) Patent Application Publication
(10) Pub. No.: US 2019/0123952 A1
(43) Pub. Date: Apr. 25, 2019

(54) HOST-DEVICE FUNCTIONALITY SUPPLEMENTATION BASED ON PORTABLE-SYSTEM RESOURCES

(71) Applicant: GM Global Technology Operations LLC, Detroit, MI (US)

(72) Inventors: Robert A. Hrabak, Birmingham, MI (US); Donald K. Grimm, UTICA, MI (US); Fan Bai, ANN ARBOR, MI (US); Dan Shan, Troy, MI (US); Leonard C. Nieman, Harrison Twp., MI (US); Karen Juzswik, YPSILANTI, MI (US)

(73) Assignee: GM GLOBAL TECHNOLOGY OPERATIONS LLC

(21) Appl. No.: 15/793,248

(22) Filed: Oct. 25, 2017

(51) Int. Cl. H04L 29/08; G06F 17/30

(52) U.S. Cl. CPC H04L 29/08558; G06F 17/30702; G06F 17/30572; H04L 29/08567

(57) ABSTRACT

In one aspect, the technology includes a portable system, for providing add-on resources to a host device, such as a vehicle host device. The portable system includes a portable-system resource, which in various embodiments is at least partially a part of a portable-system data storage. The data storage includes at least one companion application that, when executed, provides, based on operation of the portable-system resource, host-device output for use at the host device, wherein the host-device output is output that the host device could not produce on its own or is supplemental to output that the host device can produce on its own. Example portable-system resources include a central-processing unit, a graphics processor, an application shop, an app-refresh program, security or hardware accelerators, and a speech recognition or three-dimensional rendering program. The technology in various embodiments also includes the host device described herein.

### TECHNICAL FIELD

The present technology relates generally to a host device, such as automobiles, and, more particularly, to portable systems, such as a customized USB plug-in or wireless device, having a companion application that shares portable-system resources with a host device, such as an automobile. In another aspect, the technology includes the host device.

### BACKGROUND

This section provides background information related to the present disclosure which is not necessarily prior art.

While older vehicles, or modestly equipped newer vehicles, can serve most user needs, they typically lack functionality available in fully-equipped newer vehicles. Even the newest vehicles usually lack functionality that will be available in the next model year.

### SUMMARY

The present technology solves the above and other challenges. In various embodiments, the technology provides apparatus for leveraging resources of a portable system, such as a customized USB plug-in or Bluetooth low energy (BLE) device, for the benefit of host systems, such as automobiles or other vehicles.

In one aspect, the technology includes a portable system, for providing add-on resources to a vehicle host device, such as an automobile or other vehicle host device, including a hardware-based processing unit and a portable-system resource. The system also includes a non-transitory computer-readable storage component comprising at least one companion application that, when executed by the hardware-based processing unit, provides, based on operation of the portable-system resource, host-device output for use at the vehicle host device, wherein the host-device output is of a form that the vehicle host device could not produce on its own or is supplemental to output that the vehicle host device can produce on its own.

In various embodiments, the portable-system resource is selected from any of a wide variety of resources, such as a central-processing unit, a graphics processor, an application shop, an app-refresh program, security or hardware accelerators, and a speech recognition or three-dimensional rendering program. Many other example resources are outlined herein.

In various implementations, the portable-system resource includes portable-system hardware.

At least part of the portable-system resource is stored at the non-transitory computer-readable storage component in various embodiments.

The portable-system processor includes one or both of (i) a portable-system central-processing unit, wherein the host-device output includes host-device data processed by the portable-system central-processing unit and the portable-device central-processing unit, or is at least capable of supplementing the host-device central-processing processor unit; and (ii) a portable-system graphical processor, wherein the host-device output includes host-device graphical data processed by the graphical portable-system processor, and the vehicle host device, or has limited graphical processing capabilities, or the portable-device graphical processor, or at least is capable of supplementing, the graphical host-device processor.

In various embodiments, the companion application is a sole application at the portable system, or is one of many portable apparatus applications that manage the provisioning of portable-system resources to the vehicle host device.

In various embodiments, the portable system may support payment-processing functions that employ near-field communications (NFC), or RFID, protocols.

In various embodiments, the companion application, when executed by the hardware-based processing unit, determines that the vehicle host device does not have, or needs, the portable-system resource.

The resource may include a software adaptation program, which in various embodiments performs any of: (a) a personalization function that characterizes users in terms of their preferences; (b) an analytics function with respect to host-system user activity to improve subsequent operation of the host device; (c) a learning function with respect to host-system user activity to improve subsequent operation of the portable system and/or the host device; and (d) a data-mining function with respect to host-system user activity to obtain information about host-device operations or host-device user activity, or other information useful for improving operation of the host device.

The portable-system near-field or short-range transceiver may include a Bluetooth low-energy (BLE) transceiver or a near-field communications (NFC) transceiver.

In various embodiments, the portable-system remote- or cloud-computing interface comprises a cloud-based commerce program.

In another aspect, the technology includes the host device, as described herein.

Various aspects of the present technology includes non-transitory computer-readable storage devices, of the host devices or portable systems described herein—configured to perform any of the operations described, algorithms to perform the same, and the processes including the operations performed by these systems, storage devices, and algorithms.

Other aspects of the present technology will be in part apparent and in part pointed out hereinafter.

### DESCRIPTION OF THE DRAWINGS

FIG. 1 illustrates schematically an arrangement including a host apparatus, in the form of an automobile, and a portable apparatus, with a communication network and remote computing system, according to embodiments of the present technology.

FIG. 2 illustrates schematically aspects of the arrangement of FIG. 1 showing the host and portable apparatus in more detail.

The figures are not necessarily to scale and some features may be exaggerated or minimized, such as to show details of particular components.

The invention of the present disclosure and claims is not limited to the implementations illustrated by way of example.

### DETAILED DESCRIPTION

As required, detailed embodiments of the present disclosure are provided herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

I. Technology Introduction

The present disclosure describes, by various embodiments, systems for leveraging resources of a portable apparatus, such as a customized USB plug-in device, for the benefit of host apparatus, such as automobiles or other vehicles. Example portable-apparatus resources include general computing—e.g., general processing—resources, graphical processing resources, and security or other hardware-accelerator resources, to name just a few.

Portable systems can have higher level resources due to a fast product cycle. It may be easier or less expensive, for instance, to provide a new application, learning or AI program, or extra data storage by way of a portable device, such as a USB plug-in or wireless USB device, as compared to upgrading a vehicle or obtaining a new vehicle.

While select embodiments of the present technology are described in connection with transportation vehicles or modes of travel, and particularly in some cases, automobiles, the technology is not limited to these implementations.

The concepts can be extended to a wide variety of systems and devices, such as other transportation or moving vehicles including aircraft, watercraft, trucks, busses, trolleys, trains, industries extending beyond transportation such as manufacturing equipment (for example, forklift), construction machines, agricultural machinery, warehouse equipment, devices at the office, and home appliances (e.g., television, other infotainment components, refrigerator, etc.). The portable system in particular may include any personal or mobile computing device, such as phones, wearables, plug-ins, and wireless peripherals, and other.

Another implementation, which can be non-automotive, includes plug-in peer-to-peer, or network-attached-storage (NAS) devices.

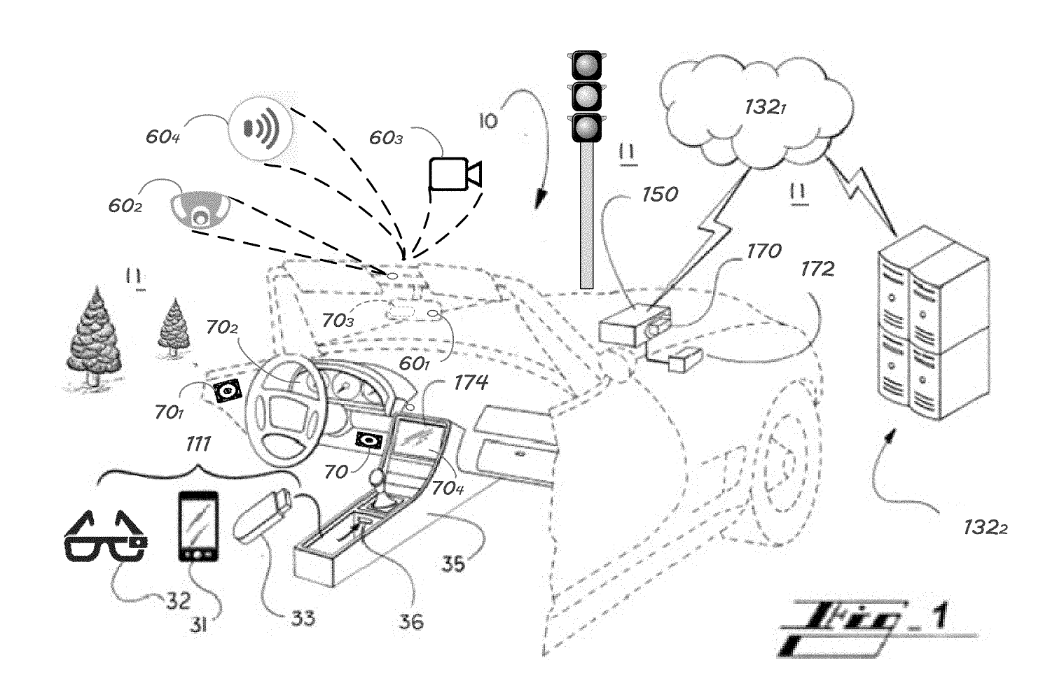

II. Arrangement and Environment—FIG. 1

Turning now to the figures and more particularly the first figure, FIG. 1 shows an example host structure or apparatus 10 in the form of a vehicle, and particularly an automobile.

The vehicle 10 has a host hardware-based controller or controller system 150. The host hardware-based controller system 150 includes a communication sub-system, including input/output components, such as ported or wired components, and wireless components 270, for communicating with portable or local computing apparatus 111 and external networks 132₁.

The portable or local apparatus 111 are referred to primary herein as portable, but may be embedded or connected to the vehicle 10.

The portable apparatus 111 is configured for wired or wireless communications with the host device 150 and in various embodiments, to other apparatus 132. Other apparatus may include external networks 132₁ and external or remote systems 132₂. By the external networks 132₁, such as the Internet, a local-area, cellular, or satellite network, vehicle-to-vehicle, pedestrian-to-vehicle, road-side infrastructure networks, the like or other, the vehicle 10 can reach portable or local apparatus 111 or remote systems 132₂, such as remote servers. A server of the remote system 132₂ may be a part of a customer-service center or system, such as the OnStar ® system (ONSTAR is a registered trademark of Onstar LLC of Detroit, Mich.), for instance.

Example portable apparatus 111 include a user smartphone 31, a user wearable device 32, and a USB mass storage device 33, and are not limited to these examples. Example wearables include smart watches, smart eyewear, and smart-jewelry (earrings, necklaces, lanyards, etc.).

Another example portable apparatus 111 is a user plug-in device, such as a USB mass storage device, or such a device configured to communicate wirelessly.

Still another example portable apparatus 111 is an on-board device (OBD) (not shown in detail), such as a wheel sensor, a brake sensor, an accelerometer, a rotor-wear sensor, a throttle-position sensor, a steering-angle sensor, a revolutions-per-minute (RPM) indicator, a brake-torque sensors, other vehicle state or dynamics-related sensor for the vehicle, with which the vehicle is retrofitted with after manufacture. The OBD(s) can include or be a part of an interface component sub-system, referenced below by numeral 172 which can include a sensor sub-system.

The vehicle controller system 150, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals.

Communications between the OBD(s) and the primary controller or microcontroller 150 are in other embodiments executed via similar or other message-based protocol.

The vehicle 10 also has various mounting structures 35. The mounting structures 35 include a central console, a dashboard, and an instrument panel. In various embodiments, the mounting structures 35 include a plug-in port 36, such as a USB port.

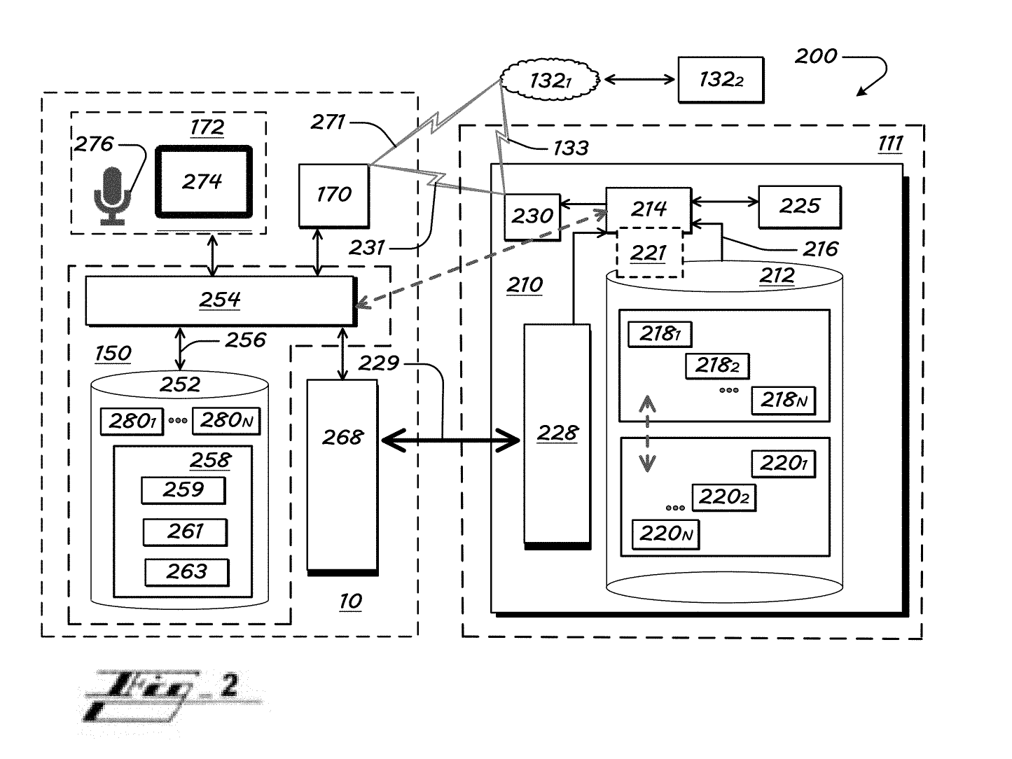

The vehicle 10 also has the referenced interface sub-system 172 including sensors providing information to the controller system 150. The sensor input to the controller 150 is shown schematically at the right, under the vehicle hood, of FIG. 2. Example host sensors are indicated by reference numerals 60—e.g., 60₁, 60₂, 60₃, 60₄.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄. Intra-vehicle-focused sensors 60₁, 60₂, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 60₃, 60₄ sense characteristics about an environment 11 comprising, for instance, billboards, buildings, other vehicles, traffic signs, traffic lights, pedestrians, etc.

The OBDs mentioned can be considered as local devices, sensors of the sub-system 172, or both in various embodiments.

Any portable apparatus 111 may in various embodiments be considered as a sensor of the sub-system 172 as well, such as in embodiments in which the vehicle 10 uses data provided by the portable apparatus 111 based on output of a local-device sensor(s). The vehicle system can use data from a user smartphone, for instance, indicating user-physiological data sensed by a biometric sensor of the phone.

The vehicle 10 also includes cabin output components 70, such as audio speakers 70₁, and an instruments panel or display 70₂. The output components may also include a dash or center-stack display screen 70₄, a rear-view-mirror screen 70₃ (for displaying imaging from a vehicle aft/backup camera), and any vehicle visual display device 274.

III. Embodiments of Host and Portable Apparatus—FIG. 2

FIG. 2 shows aspects of the host and portable apparatus 10, 111 in more detail.

The environment 200 includes the portable apparatus 111, including a portable system 210, and the host apparatus 10 (e.g., vehicle), including the host device 150.

In various embodiments, the portable apparatus 111 and host device 150 are a connected or consolidated system.

III.A. Portable Apparatus 111

The portable apparatus 111 can take any of many forms, and be referenced by any of a variety of terms—such as by peripheral device, peripheral system, connected mobile, or portable accessory or peripheral, peripheral, mobile system, mobile peripheral, portable system, and portable mass-storage system, smartphone, or wearable.

The portable apparatus 111 can be referred to as being portable based on any of various features, such as by being readily attachable and removable to/from the host apparatus 10, such as by a plug-in arrangement. Or by being mobile, such as by being wireless and compact for being readily carried about by a user. The portable apparatus 111 can include or be part of a dongle or a mobile communications device such as a smartphone.

For some embodiments, the portable apparatus 111 is embedded into the vehicle—e.g., as a plug-in daughtercard of a vehicle electronic control unit—and is capable of providing content and rendering services to the host apparatus 10. The portable apparatus 111 can be part of or connected to a host apparatus 10—e.g., an automobile or other vehicle that includes the host device 150.

While the portable apparatus 111 is described primarily herein as a portable apparatus 111, any of the embodiments described regarding a portable apparatus 111 disclose inherently embodiments in which the apparatus 111 is fully or partially embedded into a vehicle.

Although connections are not shown between all of the components of the portable apparatus 111 and the host apparatus 10, the components interact with each other to carry out the functions described herein.

The portable apparatus 111 includes a hardware-based portable system 210.

The portable system 210 includes a hardware-based storage device 212. The hardware-based storage device 212 can be referred to by other terms, such as a memory, or computer-readable medium, and can include, e.g., volatile medium, non-volatile medium, removable medium, and non-removable medium. The term hardware-based storage device and variants thereof, as used in the specification and claims, refer to tangible or non-transitory, computer-readable storage devices. The component is referred to primarily herein as a hardware-based storage device 212.

In some embodiments, storage media 212 includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The portable system 210 also includes a processing hardware unit 214 connected or connectable to the hardware-based storage device 212 by way of a communication link 216, such as a computer bus.

The processing hardware unit 214 can be referred to by other terms, such as processing hardware unit, processing hardware device, processing hardware system, processing unit, processing device, or the like.

The processing hardware unit 214 could be multiple processors, which could include distributed processors or parallel processors in a single machine or multiple machines. The processing hardware unit 214 can be used in supporting a virtual processing environment.

The processing hardware unit 214 can include or be a multicore unit, such as a multicore digital signal processor (DSP) unit or multicore graphics processing unit (GPU).

The processing hardware unit 214 can be used in supporting a virtual processing environment. The processing hardware unit 214 could include a state machine, application specific integrated circuit (ASIC), programmable gate array (PGA) including a Field PGA (FPGA), DSP, GPU, or state machine.

The portable system 210 in various embodiments comprises one or more complementing media codec components, such as a processing or hardware component, and a software component to be used in the processing. The hardware or processing component can be a part of the processing hardware unit 214.

References herein to a processor or processing hardware unit 214 executing code or instructions to perform operations, acts, tasks, functions, steps, or the like, could include the unit 214 performing the operations directly and/or facilitating, directing, or cooperating with another device or component to perform the operations.

The hardware-based storage device 212 includes structures such as modules, engines, and components, which include computer-executable instructions or code for performing functions of the present technology. The modules, engines, and components are each referred to primarily herein as modules.

Code, whether part of the modules, is executed by the processing hardware unit 214 to cause the processing hardware unit and thus the portable system 210 to perform any combination of the operations described herein regarding the portable system. Example operations include running an application, and therein receiving media content from a source, such as a third-party application server, and delivering content and any rendering instructions to the host device.

Modules can cause the processing hardware unit 214 to perform specific operations or routines of module functions.

Each of the modules and sub-modules can be referred to by any of a variety of names, such as by a term or phrase indicative of its function.

For instance, a portable-system module that determines that the host apparatus needs, or does not have, a resource or resources sufficient to meet host-apparatus needs, can be referred to as a host-device-resource-determination module or the like. A portable-system module in the form of a graphical processing unit (GPU) module, which can be used by or for the benefit of the host apparatus 10, can be referred to as a GPU-resource module, or the like. A portable-system module that provides portable-system resources to the host apparatus 10 can be referred to as a resource-delivery module, a portable-system-resource delivery module, or the like.

The design of the hardware-based storage device 212 in various embodiments includes one or more portable-system applications 218₁, 218₂, . . . , 218_{N} (where N is a positive non-zero integer). The applications 218 are described further below.

The portable system 210 also includes one or more resource modules 220₁, 220₂, . . . , 220_{N}. The resource modules 220 provide various types of software resources for use by the host device 150, such as applications or programs that are not native to the host device 150. At least one resource module, in some embodiments, resides at least partially at the storage device 212. And in some embodiments at least one resource module resides at least partially at the portable apparatus 111 outside of the storage device 212. The resource modules 220 are described further below.

The portable system 210 further includes one or more other portable-system resources 221. The other portable-system resources 221 may include hardware, such as an additional processor, in addition to the primary processor 214, or additional storage, in addition to the primary storage 212 of the portable system 210, or additional sensors. The other portable-system resources 221 are described further below.

The applications 218 include at least one companion, or resource-sharing, application 218₁—in various embodiments, the device 212 includes only one, single resource-sharing, application 218₁. Whether one or more applications perform the portable-system resource sharing functions, each application may be referred to as a companion application in that it allows the portable system 210 and the portable apparatus 111 to be a companion, providing helpful or necessary resources to the host device 150 and the host apparatus 10.

The applications 218 are in various embodiments made or provided by an original equipment manufacturer (OEM) of the host device, e.g., automobile. The applications 218 can be proprietary in any one or more of a variety of ways, such as by:

(1) being configured only for use with a particular type of host device 150, such as a host device made by the OEM,

(2) being configured only for use with a particular type of portable system, such as a portable system made by the OEM,

(3) being configured for use only with portable systems approved by the OEM for the use, and

(4) being configured for use only with host devices approved for the use by the OEM.

The storage device 212 may also include a synchronization module. The portable-system synchronization module performs functions at the host-device side (e.g., vehicle side) for executing the arrangement 200 of the present technology. As mentioned, functions of the arrangement in various embodiments includes executing programs, applications, and protocols at the portable system 210 to coordinate (e.g., timing of) data-processing and data-sharing operations between the host device 150 and the portable system 210. The portable-system synchronization module includes code or protocols that when executed by the processing hardware unit 254 performs any suitable functions for establishing a connection, such as by handshake processes, synchronizing, or otherwise facilitating and managing communications between the portable system 210 and the host device 150. The portable-system synchronization module can include or work with media or infotainment-sharing app(s) (218_{N}) at the portable system 210, such as a three-dimensional (3D) rendering app, program, or module, resulting in 3D video rendering at the host device. A host-device synchronization module in various embodiments communicates with the portable-system synchronization module.

The resource modules 220₁, 220₂, . . . , 220_{N} include any of a wide variety of resources that can be used by the host device 150.

Example resources include, but are not limited to:

(i) Speech recognition software that the host device 150 does not have natively and can use;

(ii) Cloud services that the host device 150 does not have natively and can use;

(iii) Applications or programs (i.e., publicly available, or provided by a second party) that the host device 150 does not have natively and can use;

(iv) Enhanced graphic-rendering software, such as OpenGL®, for 3-D map rendering, or for virtual-reality applications, that the host device 150 does not have natively and can use (OpenGL is a registered trademark of Silicon Graphics, Inc., of Mountain View, Calif.);

(v) Flexible application shop and refresh system including, for instance, software, which the host device 150 does not have natively, configured to obtain updates for the host device 150, such as OTA updates for a host-device OS or application, and push the updates to the host device 150;

(vi) Software-adaptation components configured to, when executed at the portable system 210, operate for (A) personalization applications or programs operating at the host device 150, (B) performing analytics and learning functions with respect to host-system user activity for improving subsequent operation of the portable system 210 and/or host device 150 with respect to serving the host-device user, and/or (C) performing data mining functions, to obtain helpful information about host-device operations or user activity relevant to the host device 150, or information that would be useful for the host device 150, as a few examples;

(vii) Gesture control software, configured to, based on output from one or more portable-system sensors and/or host-device sensors perceiving user gesture(s), determine a corresponding host-vehicle function desired by the user (e.g., answer incoming call, change station); and

(viii) Other-user-communication control software, configured to, based on output from one or more portable-system sensors and/or host-device sensors recognizing user communications (e.g., audible statements, words, utterances), determine a corresponding host-vehicle function desired by the user.

Software that resides on both the host and portable devices will enable the host device to deploy specific software functions to the portable device. For example, the host device may capture an audio input stream from the vehicle microphone and send the resulting audio data to the portable device for processing into text.

In another example, the portable device can function as a frontend interface for different types of remote services, such as a weather service. In this example, the host device receives weather information from the portable device over a local interface. The particular remote service that the portable device uses to acquire weather information can be changed according to technical (e.g., accuracy) or business (e.g., cost) reasons using the OTA capabilities of the portable device.

The one or more other resources 221 include any of a wide variety of resources. The other resources 221 typically comprise more than software; the resource modules 220 may also include more than software, such as the storage or processing components. Some resources of the portable system 210 may be part also of the overall portable apparatus 111. And some of the resources may be considered as both a portable-system resource 221 and a resource module 220.

Example other resources 221 include, but are not limited to:

(a) Central processing resource, such as CPU, that the host device 150 does not have in sufficient capacity, (such as a multi-core CPU—e.g., a 3x Core, 4x Core, . . . , Nx Core (wherein N is a positive non-zero integer);

(b) Graphics processing resource, such as GPU that the host device 150 does not have natively or in sufficient capacity;

(c) Field-programmable gate array resource, such as an FPGA that the host device 150 does not have natively—the FPGA can be used by the host device 150 or portable system 210 to perform functions such as deep learning, signal processing, and security;

(d) Security accelerator, such as a security accelerator that the host device 150 does not have (the host may have a lower level security accelerator, for instance, or none at all);

(e) Hardware accelerator, such as a hardware accelerator that the host device 150 does not have (the host may have a lower level hardware accelerator, for instance, or none at all);

(f) Additional storage, such as flash storage at the portable system 210, that can be used by or at least for the benefit of the host system 150—the additional storage may include, for instance, 100GBs of storage space to supplement the native storage capacity at the host device 150;

(g) Communication apparatus, program, etc. which may include one or more suitable transceivers and supporting software, which the host device 150 does not have natively, or the host device 150 can use in addition to the communication at the host device 150, such as Bluetooth low-energy (BLE), near-field communications (NFC), WiFi hotspot, or a next-generation cellular, satellite, or other low-, medium-, or long-range communication standard;

(h) Personal health monitoring apparatus, program, standard, protocol, etc., which may include or be supported by BLE or other short-range communication components, and obtain or at least use user biometric data, which in some cases is obtained by a biometric sensor of the host apparatus 10 or the portable apparatus 111;

(i) Host-device monitoring apparatus, program, etc. (e.g., vehicle monitoring apparatus, monitoring e.g., tire-pressure monitoring) apparatus, which may include or be supported by BLE or other short-range communication components;

(j) User-device locator apparatus, program, etc., for locating, e.g., a user phone or fob, wherein the apparatus may include or be supported by BLE or other short-range communication components;

(k) Proximity apparatus, program, etc., such as vehicle approaching-detection apparatus;

(l) Payment apparatus, program, etc., which may include or be supported by NFC, RFID, or other suitable interface or communication standard;

(m) Cloud-based commerce apparatus, program, etc., which may include or be supported by NFC, RFID, or other suitable interface or communication standard;

(n) Audio-handover apparatus, program, etc., which may include or be supported by NFC, RFID, or other suitable interface or communication standard (e.g., to handover media playback or phone call from a mobile device to the vehicle audio system);

(o) Mobile-device projection apparatus, program, etc., for to-host-projection, wherein the apparatus may include or be supported by NFC, RFID, or other suitable interface or communication standard;

(p) Data-insertion apparatus, program, etc., for to-host data insertion, wherein the apparatus may include or be supported by NFC, RFID, or other suitable interface or communication standard, such as to provide navigation (e.g., transfer navigation instructions from a mobile device to the vehicle navigation system), personalization (obtaining and providing, e.g., user settings or learned preferences), and data retrieval (fuel, tire pressure, etc.) functionality; and (q) Sensors hardware and/or software that the host device 150 does not have natively, such as user activity or characteristics sensors (e.g., biometric), user/vehicle movement sensors, environmental sensors (e.g., altitude, humidity, etc.).

The hardware-based storage device 212 in various embodiments includes a file sub-system (not shown in detail), which can include a first level cache and in some implementations also a second level cache.

The hardware-based storage device 212 in various embodiments includes a media codec component (not shown in detail), such as a processing, or hardware, component, and a software component.

The hardware-based storage device 212 in various embodiments includes a framebuffer capture component (not shown in detail). A display screen framebuffer can be, for example, a transferred video source, such as in the form of a data content package, captured by the framebuffer capture component.

The storage device 212 in various embodiments stores at least some of the data received and/or generated, and to be used in processing, in a file-based arrangement corresponding to the code stored therein. For instance, when an FPGA is used, the hardware-based storage device 212 can include configuration files configured for processing by the FPGA.

Any of the hardware-based storage device 212 components may be combined, separated, or removed. References herein to portable-system operations performed in response to execution of any memory 212 component can be performed by execution of another, or a combined or separated, memory 212 component. For instance, if instructions of a first component of code is described as being configured to cause the processing hardware unit 214 to perform a certain operation or set of operations, instructions of another component of the memory, including or fully distinct form the first code, 212 can be configured to cause the processing hardware unit 214 to perform the operation(s).

In some embodiments, the hardware-based storage device 212 includes code of a dynamic programming language (not called out in detail in the drawings), such as JavaScript, Java or a C/C++ programming language. The host device 150 includes the same programming language. The programming-language component of the host device 150, in some implementations includes an application framework, such as the media application mentioned and/or an application manager for managing operations of the media application at the host device 150.

The programming language code (PLC) can define settings for communications between the portable system 210 and the host device 150, such as features of one or more application program interfaces (APIs) by which the portable apparatus 111 and the host device 150 communicate.

The portable apparatus 111 in some embodiments includes at least one human-machine interface (HMI) component 225. For implementations in which the interface component 225 facilitates user input to the processing hardware unit 214 and output from the processing hardware unit 214 directly to the user from the portable system 10, the interface component 225 can be referred to as an input/output (I/O) component.

As examples, the interface component 225 can include, or be connected to, a sensor configured in any of a variety of ways to receive user input. In various implementations the interface component 225 includes at least one sensor configured to detect user input provided by, for instance, a touch, an audible sound or a non-touch motion or gesture.

A touch-sensor interface component can include a mechanical actuator, for translating mechanical motion of a moving part or touch of a touch-sensitive sensor, such as a mechanical knob or button, to an electrical or digital signal. A touch sensor can also include a touch-sensitive pad or screen, such as a surface-capacitance sensor. The interface component 225 can include a microphone. The interface component 225 can also include infrared components of a touch-sensor interface, as well.

For detecting gestures, the interface component 225 can include or use a projected-capacitance sensor, an infrared laser sub-system, a radar sub-system, or a camera sub-system, by way of examples.

The interface component 225 is connected to the processing hardware unit 214 for passing user input received as corresponding signals or messages to the hardware-based processing unit.

In various implementations the interface component 225 includes or is connected to any suitable output devices—for example, a visual or audible indicator such as a light, digital display, or tone generator, for communicating output to the user.

The interface component 225 can be used to affect functions and settings of one or both of the portable apparatus 111 and the host device 150 based on user input. Signals or messages corresponding to inputs received by the interface component 225 are transferred to the processing hardware unit 214, which, executing code of the hardware-based storage device 212, sets or alters a setting or function at the portable system 210. An example setting or function includes which portable-system resource (220₁, . . . , 220_{N}) is provided or made available to the host device 150, or a manner by which the resource is provided or made available to the host device 150.

Inputs received can also trigger generation of a communication, such as an instruction or message, for the host device 150, and sending the communication to the host device 150 for setting or altering a function or setting of the host device 150.

The portable apparatus 111 is in some embodiments configured to connect to the host device 150 by a wireless communication 231 or by a hard, or wired connection 229. The wired connection is referred to primarily herein as being wired in a non-limiting sense. The connection can include components connecting wires, such as the USB plug-and-port arrangement described, or wireless components can include as wireless USB.

In some embodiments, the connection is configured according to higher throughput arrangements, such as using an HDMI port or a VGA port.

In various embodiments, wired communications are effected between a data-communications plug 228 of the portable system 10 and a matching data-communications port 268 of the host device 150.

The portable apparatus 111 can, as mentioned, be configured as a dongle, in which case an example data-communications plug 228 is a USB plug, for connecting to a USB port 268 of the host device 150.

In these ways, advanced functions can be made available by way of a relatively low-rate connection, such as USB device class components, whereas they would not otherwise be. And if a higher- or high-capability class device is available (e.g., if the vehicle is already configured with or for such device class), the system can be configured to directly use the higher-capability class device to provide the advanced functions.

While the portable apparatus 111 is in some embodiments a portable mass-storage device, more advanced USB device classes such as Media Transfer Protocol (MTP) could be supported.

The portable system 2101 is configured in various embodiments to operate any one or more of a variety of types of computer instructions that it may be programmed with for dynamic operations and/or that it may receive for dynamic processing at the portable system 210.

By numeral 230 in FIG. 2 is referenced a wireless input or input/output (I/O) device—e.g., transceiver—or simply a transmitter. Wireless communications with the host device 150 and external apparatus 132 [external networks 132₁ (Internet, etc.) and remote systems 132₂ (servers, etc.)], are referenced by numerals 231, 133, respectively.

The wireless device 230 in various embodiments communicates with any of a wide variety of networks, including cellular communication networks, satellite networks, and local networks such as by way of a roadside-infrastructure or other local wireless transceiver, beacon, or hotspot.

The wireless device 230 can also communicate with near-field communication (NFC) devices to support functions such as mobile payment processing, or communication setup/handover functions, or any other use cases that are enabled by NFC. The wireless device 230 can include for example, a radio modem for communication with cellular communication networks.

The communication devices 228, 230 in various embodiments include or at least use socket application program interfaces (APIs), working in conjunction with corresponding software of the host device 150 to facilitate secured communications between the host device 150 and portable system 210.

III.B. Host Apparatus 10

The host apparatus 10, such as an automobile or other vehicle of transportation includes a hardware-based computing host device 150, shown schematically in FIGS. 1 and 2.

In addition to the host-device componentry described in connection with FIG. 1, the host device 150 includes, as shown in FIG. 2, a memory, or computer-readable medium 252, such as volatile medium, non-volatile medium, removable medium, and non-removable medium. The term computer-readable media and variants thereof, as used in the specification and claims, refer to tangible or non-transitory, computer-readable storage devices. The component is referred to primarily herein as a storage device 252.

In some embodiments, storage device 252 includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The host device 150 also includes an embedded computer hardware-based processing unit 254 connected or connectable to the storage device 252 by way of a communication link 256, such as a computer bus.

The hardware-based processing unit could be multiple processors, which could include distributed processors or parallel processors in a single machine or multiple machines. The hardware-based processing unit can be used in supporting a virtual processing environment. The hardware-based processing unit could include a state machine, application specific integrated circuit (ASIC), programmable gate array (PGA) including a Field PGA, or state machine. References herein to hardware-based processing unit executing code or instructions to perform operations, acts, tasks, functions, steps, or the like, could include the hardware-based processing unit 254 performing the operations directly and/or facilitating, directing, or cooperating with another device or component to perform the operations.

The storage device 252 in various embodiments stores at least some of the data received and/or generated, and to be used in processing, in a file-based arrangement corresponding to the code stored therein. For instance, when an FPGA is used, the hardware-based storage device 252 can include configuration files configured for processing by the FPGA.

The storage device 252 includes computer-executable instructions, or code. The computer-executable code is executable by the hardware-based processing unit 254 to cause the hardware-based processing unit, and thus the host device 150, to perform any combination of the functions described in the present disclosure regarding the host device 150.

The storage unit 252 of the host device 150 in various embodiments includes an application(s) framework or module, an audio-media module, a framebuffer or visual-media module, and a HMI module, which are all considered illustrated by the schematically shown storage unit 252.

The storage device 252 of the host device 150 in various embodiments also includes any of: other code or data structures, such as a file sub-system; and a dynamic-programming-language (e.g., JavaScript, Java or a C/C++ programming language—not shown in detail in the figures).

Any such storage-unit components may be combined, separated, or removed. References herein to host system operations performed in response to execution of any storage-unit component can be performed by execution of another, or a combined or separated, memory component. For instance, if first code is described as being configured to cause the hardware-based processing unit 254 to perform a certain operation or set of operation(s), other code, including or fully distinct form the first code, can be configured to cause the hardware-based processing unit 254 to perform the operation(s).

The file sub-system can include a first level cache and a second level cache. The file sub-system can be used to store media, such as video or image files, before the hardware-based processing unit 254 publishes the file(s).

The dynamic-programming-language (e.g., JavaScript, Java or a C/C++ programming language (not shown in detail) and/or application framework can be part of the second level cache. The dynamic-programming-language is used to process media data, such as image or video data, received from the portable system 210. The programming language code can define settings for communications between the portable system 210 and the host device 150, such as characteristics of one or more APIs.

Design of the hardware-based storage device 252 of the host device 150 in various embodiments includes at least one or more host-device application(s) 280₁, . . . , 280_{N}.

The storage device 252 also includes host-device operating system(s) 259, driver(s) 261, and may include or be in communication with any of a wide variety of peripherals 263.

As with the application/s 218_{N} of the portable system 210, the applications 280 of the host device 150 are in various embodiments made or provided by an original equipment manufacturer (OEM) of the host device, e.g., automobile. The applications 218 can be proprietary in any one or more of a variety of ways, such as by:

(1) being available only on particular host devices made by the OEM;

(2) being available only on particular host devices approved by the OEM, and so specially configured for authorized use at the host device, e.g., vehicle, with authorized portable systems 111; and

(3) regarding communications with external devices or external-device apps, being compatible for communication with only external devices (e.g., the portable apparatus 111), and/or external-device apps thereof, that are approved by the OEM, and thereafter configured specially for authorized interaction with the host device 150 or parts thereof.

The host-device applications 280 are configured to, when executed by the processing hardware unit 254, perform any suitable operation or protocol for incorporating functions of the portable system 210. Example operations include but are not limited to any one or more of:

determining that the host device 150 can use at least one resource (hardware and/or software) that it does not have;

determining that the portable system 210 has the resource(s);

preparing a request to send to the portable system 210 for the resource(s);

sending the request to the portable system 210 for the resource(s); and

interfacing with the portable system 210 to obtain the needed resource, or otherwise directly or indirectly receiving benefit of the resource of the portable system (such as by the portable system 210 providing data to a cloud system or remote server that in turn provides data to the host device 150).

The portable system 210 may also perform analogous operations to any of these. The portable system 210 may for instance determine that the host device 150 needs, does not include, or could use a sharable resource of the portable system 210, such as by determining that the host device does not have a resource, or has a performance shortcoming, and determining that the portable system has a sharable resource that can address the issue.

The storage device 252 also includes a host-device synchronization module in various embodiments. The host-device synchronization module performs functions at the host-device side (e.g., vehicle side) for executing the arrangement 200 of the present technology. As mentioned, functions of the arrangement in various embodiments includes executing programs, applications, and protocols at the host device 150 to coordinate (e.g., timing of) data-processing and data-sharing operations between the host device 150 and the portable system 210. The host-system synchronization module includes code or protocols that when executed by the processing hardware unit 254 performs any suitable functions for establishing connection, such as by handshake processes, synchronizing, or otherwise facilitating and managing communications, between the portable system 210 and the host device 150. The host-device synchronization module can include or work with media or infotainment-deliver app(s) (280_{N}) at the host device 150, such as a video-rendering app. The host-system synchronization module in various embodiments communicates with the portable-system synchronization module.

As referenced regarding FIG. 1 and shown in FIG. 2, the host device 150 also includes or is in communication with the one or more mentioned interface components 172, such as an HMI component, in various embodiments. For implementations in which the components 172 facilitate user input to the hardware-based processing unit 254 and output from the hardware-based processing unit 254 to the user, the components can be referred to as input/output (I/O) components.

For output, the interface components 172 can include a visual-output or display component 274, such as a screen, and an audio output such as a speaker. In a contemplated embodiment, the interface components 172 include structure for providing tactile or haptic output, such as a vibration to be sensed by a user, such as by way of a steering wheel or vehicle seat to be sensed by an automobile driver.

The interface components 172 are configured in any of a variety of ways to receive user input. The interface components 172 can include for input to the host device 150, for instance, a mechanical or electro-mechanical sensor device such as a touch-sensitive display, which can be referenced by numeral 274, and/or an audio device 276 such as an audio sensor—e.g., microphone—or audio output such as a speaker. In various implementations, the interface components 172 includes at least one sensor. The sensor is configured to detect user input provided by, for instance, touch, audibly, and/or by user non-touch motion, such as by gesture.

A touch-sensor interface component can include a mechanical actuator, for translating mechanical motion of a moving part such as a mechanical button, to an electrical or digital signal. The touch sensor can also include a touch-sensitive pad or screen, such as a surface-capacitance sensor. For detecting gestures, an interface component 172 can use a projected-capacitance sensor, an infrared laser sub-system, a radar sub-system, or a camera sub-system, for example.

The interface component 172 can be used to receive user input for affecting functions and settings of one or both of the portable system 210 and the host device 150. Signals or messages corresponding to user inputs are generated at the component 172 and passed to the hardware-based processing unit 254, which, executing code of the storage device 252, sets or alters a function or setting at the host device 150, or generates a communication for the portable system 210, such as an instruction or message, and sends the communication to the portable system 210 for setting or altering a function or setting of the portable system 210. An example setting or function includes which portable-system resource (220₁, . . . , 220_{N}) the host device 150 requests or otherwise obtains from the portable system 210, or a manner, such as timing, by which the resource is requested or received to the host device 150.

The host device 150 is in some embodiments configured to connect to the portable apparatus 111 by wired connection 229. The host device 150 is in a particular embodiment configured with or connected to a data-communications port 268 matching the data-communications plug 228 of the portable apparatus 111. An example plug/port arrangement provided is the USB arrangement mentioned.

In some embodiments, the host device 150 is configured for wireless communications 231 with the portable apparatus 111. A wireless input, or input/output (I/O) device—e.g., transceiver—of the host device 150 is referenced by numeral 270 in FIG. 1. The hardware-based processing unit 254, executing code of the storage device 252, can wirelessly send and receive information, such as messages or packetized data, to and from the portable apparatus 111 and the external apparatus 132 [external networks 132₁ (Internet, etc.) and remote systems 132₂ (servers, etc.)] by way of the wireless device 270 as indicated by numerals 231, 271, respectively. Any of various wireless protocols can be used, such as but not limited to Bluetooth, or wireless USB.

IV. Algorithms and Functions

The schematic component drawing of FIG. 2 is intended to, along with showing structure, show process and algorithmic flow.

Connections and interactions between components are not in every instance shown to simplify the drawings, such as regarding the applications 218_{N}, resource modules 220, other resources 221, and some interactions are shown, such as by brackets or arrows.

Regarding the flows shown and described above, it should be understood that operations are not necessarily presented in a particular order and that performance of some or all the operations in an alternative order is possible and contemplated. The operations have been presented in the demonstrated order for ease of description and illustration. Operations can be added, omitted and/or performed simultaneously without departing from the scope of the appended claims.

It should also be understood that any of the flows can be ended at any time. In certain embodiments, some or all operations of this process, and/or substantially equivalent operations are performed by execution by the hardware-based processing units 214, 254 of computer-executable code of the storage devices 212, 252 provided herein.

Operations described, by way of example in connection with embodiments herein, as being performed by a certain structure—e.g., device, module or sub-module—need not in every embodiment be performed by that structure. Activity described as being performed by the portable apparatus 111, or particularly the processing unit 214 or a module thereof, may be performed by a another module of the portable apparatus 111, or by a remote apparatus, for instance, or the host device 150, having corresponding structure, such as the subject module(s)/sub-module(s) for performing the activity.

V. Example Benefits and Advantages

Many of the benefits and advantages of the present technology described above. The present section restates some of those and references some others. The benefits described are not exhaustive of the benefits of the present technology.

The technology allows leveraging of portable system resources, which frequently include a greater number of capabilities in terms of computation, storage and connectivity compared to embedded vehicle systems due to a fast product cycle. For instance, it may be easier or less expensive to provide a new application, learning or AI program, or extra data storage by way of a portable device, such as a USB plug-in or wireless USB device as compared to upgrading a vehicle or of course compared to obtaining a new vehicle.

Financial cost is thus saved in operation of the present technology—e.g., the customer can experience the latest technology benefits in an older vehicle by purchasing a low-cost portable device as compared to purchasing a new vehicle.

Vehicle processing and bandwidth costs can also be saved in operation of the present technology, as the portable device performs functions used by or for the benefit of the host system, and so the host system need not perform such functions, or perform such functions alone or without the support of the portable system.

Legacy host apparatus (e.g., vehicles) benefit from better or additional resources—hardware and/or software—vis-à-vis original or native resources at the host device.

VI. Conclusion

Various embodiments of the present disclosure are disclosed herein. The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A portable system, for providing add-on resources to a vehicle host device, comprising:
a hardware-based processing unit;
a portable-system resource; and
a non-transitory computer-readable storage component comprising at least one companion application that, when executed by the hardware-based processing unit, provides, based on operation of the portable-system resource, host-device output for use at the vehicle host device, wherein the host-device output is of a form that the vehicle host device could not produce on its own or is supplemental to output that the vehicle host device can produce on its own;
the portable-system resource being selected from a group consisting of:
a portable-system computing processor, wherein the host-device output includes host-device data processed by the portable-system processor and the portable-device computing processor has higher processing capability than a host-device processor;
a portable-system remote- or cloud-computing interface that the vehicle host device does not have;
a portable-system enhanced graphic-rendering program that the vehicle host device does not have natively;
a portable-system application shop;
a portable-system application-refresh program;
a portable-system software-adaptation program;
a portable-system field-programmable gate array (FPGA), wherein the vehicle host device does not have an FPGA natively or the vehicle host device uses the portable-system FPGA because the portable-system FPGA has higher capability than a host-device FPGA;
a portable-system security accelerator program;
a portable-system hardware accelerator program;
a portable-system short-range transceiver that the vehicle host device does not have natively:
a portable-system personal health monitoring apparatus;
a portable-system host-device monitoring program;
a portable-system user-mobile-device locator apparatus;
a portable-system audio-handover program;
a portable-system data insertion program; and
a payment-processing program.

2. The portable system of claim 1 wherein at least part of the portable-system resource is stored at the non-transitory computer-readable storage component.

3. The portable system of claim 1 wherein the portable-system resource includes portable-system hardware.

4. The portable system of claim 1 wherein the portable-system processor comprises one or both of:
a portable-system central-processing processor, wherein the host-device output includes host-device data processed by the portable-system central-processing processor and the portable-device central-processing processor has higher processing capability than a host-device central-processing processor; and
a portable-system graphical processor, wherein the host-device output includes host-device graphical data processed by the graphical portable-system processor, and the vehicle host device does not have a graphical processor or the portable-device graphical processor has higher processing capability than a graphical host-device processor;

5. The portable system of claim 1 wherein the companion application is a sole application at the portable system managing provision of the portable-system resource to the vehicle host device.

6. The portable system of claim 1 further comprising a near-field communication protocol, wherein the payment-processing program uses near-field communications.

7. The portable system of claim 1 wherein the companion application, when executed by the hardware-based processing unit, determines that the vehicle host device does not have, or needs, the portable-system resource.

8. The portable system of claim 1 wherein the software-adaptation program is configured to perform at least one function selected from a group consisting of:
a personalizing function a vehicle-host-device program or application with respect to a user of the portable system and the vehicle host device;
an analytics function with respect to host-system user activity to improve subsequent operation of the host device;
a learning function with respect to host-system user activity to improve subsequent operation of the portable system and/or the host device; and
a data-mining function with respect to host-system user activity to obtain information about host-device operations or host-device user activity, or other information useful for improving operation of the host device.

9. The portable system of claim 1 wherein the short-range transceiver comprises a Bluetooth low-energy transceiver or a near-field communications transceiver.

10. The portable system of claim 1 wherein the portable-system remote- or cloud-computing interface comprises a cloud-based commerce program.

11. The portable system of claim 1 wherein the vehicle host device is an automobile host device.

12. A portable-system computer-readable storage device, for providing add-on resources to a vehicle host device, comprising:
a non-transitory computer-readable storage component comprising at least one companion application that, when executed by the hardware-based processing unit, provides, based on operation of the portable-system resource, portable-system resource-dependent output for use at the vehicle host device, wherein the portable-system resource-dependent output is of a form that the vehicle host device could not produce on its own or is supplemental to output that the vehicle host device can produce on its own;
the portable-system resource being selected from a group consisting of:
a portable-system computing processor, wherein the host-device output includes host-device data processed by the portable-system processor and the portable-device computing processor has higher processing capability than a host-device processor;
a portable-system remote- or cloud-computing interface that the vehicle host device does not have;
a portable-system enhanced graphic-rendering program that the vehicle host device does not have natively;
a portable-system application shop;
a portable-system application-refresh program;
a portable-system software-adaptation program;
a portable-system field-programmable gate array (FPGA), wherein the vehicle host device does not have an FPGA natively or the vehicle host device uses the portable-system FPGA because the portable-system FPGA has higher capability than a host-device FPGA;
a portable-system security accelerator program;
a portable-system hardware accelerator program;
a portable-system near-field or short-range transceiver that the vehicle host device does not have natively;
a portable-system personal health monitoring apparatus;
a portable-system host-device monitoring program;
a portable-system user-mobile-device locator apparatus;
a portable-system audio-handover program;
a portable-system data insertion program; and
a payment-processing program.

13. The portable-system computer-readable storage device of claim 12 wherein the portable-system processor comprises one or both of:
a portable-system central-processing processor, wherein the host-device output includes host-device data processed by the portable-system central-processing processor and the portable-device central-processing processor has higher processing capability than a host-device central-processing processor; and
a portable-system graphical processor, wherein the host-device output includes host-device graphical data processed by the graphical portable-system processor, and the vehicle host device does not have a graphical processor or the portable-device graphical processor has higher processing capability than a graphical host-device processor;

14. The portable-system computer-readable storage device of claim 12 wherein the companion application is a sole application at the portable system managing provision of the portable-system resource to the vehicle host device.

15. The portable-system computer-readable storage device of claim 12 wherein the payment-processing program uses a near-field communication protocol.

16. The portable-system computer-readable storage device of claim 12 wherein the companion application, when executed by the hardware-based processing unit, determines that the vehicle host device does not have, or needs, the portable-system resource.

17. The portable-system computer-readable storage device of claim 12 wherein the software-adaptation program is configured to perform at least one function selected from a group consisting of:
a personalizing function a vehicle-host-device program or application with respect to a user of the portable system and the vehicle host device;
an analytics function with respect to host-system user activity to improve subsequent operation of the host device;
a learning function with respect to host-system user activity to improve subsequent operation of the portable system and/or the host device; and
a data-mining function with respect to host-system user activity to obtain information about host-device operations or host-device user activity, or other information useful for improving operation of the host device.

18. The portable system computer-readable storage device of claim 12 wherein the portable-system remote- or cloud-computing interface comprises a cloud-based commerce program.

19. The portable system computer-readable storage device of claim 12 wherein the vehicle host device is an automobile host device.

20. A vehicle host device, for obtaining and using a portable-system resource, comprising:
a hardware-based processing unit; and
a non-transitory computer-readable storage component comprising at least one resource-dependent application that, when executed by the hardware-based processing unit, obtains, from the portable system, and uses for host-device functionality to serve a host-device user, portable-system-resource-dependent output for use at the vehicle host device, wherein the portable-system-resource-dependent output is of a form that the vehicle host device could not produce on its own or is supplemental to output that the vehicle host device can produce on its own;
the portable-system resource being selected from a group consisting of:
a portable-system computing processor, wherein the host-device output includes host-device data processed by the portable-system processor and the portable-device computing processor has higher processing capability than a host-device processor;
a portable-system remote- or cloud-computing interface that the vehicle host device does not have;
a portable-system enhanced graphic-rendering program that the vehicle host device does not have natively;
a portable-system application shop;
a portable-system application-refresh program;
a portable-system software-adaptation program;
a portable-system field-programmable gate array (FPGA), wherein the vehicle host device does not have an FPGA natively or the vehicle host device uses the portable-system FPGA because the portable-system FPGA has higher capability than a host-device FPGA;
a portable-system security accelerator program;
a portable-system hardware accelerator program;
a portable-system near-field or short-range transceiver that the vehicle host device does not have natively;
a portable-system personal health monitoring apparatus;
a portable-system host-device monitoring program;
a portable-system user-mobile-device locator apparatus;
a portable-system audio-handover program;
a portable-system data insertion program; and
a payment-processing program.
